(19) United States
(12) Patent Application Publication
(10) Pub. No.: US 2007/0191025 A1
(43) Pub. Date: Aug. 16, 2007

(54) LOCATING DEVICE AND SYSTEM

(75) Inventors: Jennifer K. McBrierty, Freeport, ME (US); Tracy L. Alves, Gorham, ME (US); Michael J. Connors, Naples, FL (US); Gavin Teale, Kent (GB); John Ho, Taoyuan (TW)

Correspondence Address: FINCH & NGUYEN PLLC, P.O. BOX 1358, CONCORD, NH, 03302, US

(73) Assignee: Gemini Technologies Global Ltd.

(21) Appl. No.: 11/673,817

(22) Filed: Feb. 12, 2007

Related U.S. Application Data
(60) Provisional application No. 60/772,690, filed on Feb. 13, 2006.

(51) Int. Cl. H04Q 7/20

(52) U.S. Cl. 455/456.2

(57) ABSTRACT

A device, method and system for locating and/or monitoring a person or thing. The system may include a locating device for determining global position, a remote device for initiating a location or monitoring request and a central controller for communicating with each of the locating device and the remote device. Remote devices may include cellular phones, telephones, email devices and internet devices.

### RELATED APPLICATION

This application claims benefit of U.S. Provisional Patent Application Ser. No. 60/772,690, titled “LOCATING DEVICE AND SYSTEM,” filed Feb. 13, 2006 and which is hereby incorporated by reference herein.

### BACKGROUND

1. Field of Invention

The invention relates to systems, methods and devices for locating and tracking and, in particular, to systems, methods and devices for remotely locating people, animals and objects.

2. Discussion of Related Art

Methods for tracking property and people have improved greatly with the implementation of advanced technology such as GPS and wireless communication.

Devices currently exist to allow one person to track the location of another. For example, U.S. Pat. No. 6,243,039 to Elliot describes a system that can track the current and historical locations of a GPS locator device carried by a person. The person's location can be monitored via the Web by providing graphical maps indicating the location of the party.

In U.S. Pat. No. 6,838,998 to Brown, et al, another Internet based personal tracking system is provided where a position signal is transmitted by a locating device in response to a call signal being received from a web host. In this manner, a person can query a web host, which in turn will query a location device, such as a GPS device, which in turn will return its location to the web host, making it available to the querying party at a remote Internet location.

In United States Patent Application 2004/0164867 A1 to Jormalainen, a monitoring system is described that allows a person with a locating device to set physical boundaries that are not to be breached. Using this technique, the user records two or more boundary positions in the device and then sends a message to a web server providing this data. When the boundaries are exceeded, notification can be provided to a piece of terminal equipment

Each of these publications describes an advancement in the field, however, these systems may be too complicated and/or burdensome to be used practically by families today. Devices and systems that provide additional information and functionality without requiring additional user input would be welcomed.

### SUMMARY OF INVENTION

The subject matter of this application may involve, in some cases, interrelated products, alternative solutions to a particular problem, and/or a plurality of different uses of a single system or article.

In one aspect a method of transmitting a first party's location to a second party is provided, the method comprising recognizing at the first party's location a transmission made from the second party to the first party, transmitting a data packet from the first party's location to a central controller, the data packet including location data and a source identifier that identifies the second party, and sending the first party's location data from the central controller to the second party's cellular phone and/or email address.

In another aspect, a device for providing a first party's location to a second party is provided, the device comprising a GPS receiver, a wireless receiver, an electronic storage medium, a microprocessor in communication with the GPS receiver, the wireless receiver and the electronic storage medium, and instructions stored on the electronic storage medium, the instructions for determining if the source of an incoming transmission is from a predetermined originator ID and for sending a data packet to a central controller, the data packet including location data and data identifying the ID of the incoming transmission.

In another aspect a device for providing a first party's location to a second party is provided, the device comprising a GPS receiver, a wireless receiver, a monitor, an electronic storage medium, a microprocessor in communication with the GPS receiver, the wireless receiver, the monitor and the electronic storage medium, and instructions stored on the electronic storage medium, the instructions for determining if the source of an incoming transmission is from a pre-determined phone address and for activating the monitor on the device wherein the device transmits data received from the monitor.

In another aspect, a method of defining a boundary area is provided, the method comprising receiving data at a locating device, the data defining the radius of a desired boundary area, activating the locating device to instruct the device to store its current location in memory, determining a second location of the locating device after the device has moved, and determining if the second location of the device has exceeded the radius.

In another aspect, a system is provided comprising a central controller including a processor, a memory medium, a transmitter and a receiver, a locating device capable of sending location data to the central controller, instructions stored on the memory medium for receiving a first location from the locating device, receiving a second location from the locating device, determining if the distance between the first and second locations exceeds a predetermined amount and transmitting notification data to a party when the distance between the first and second locations exceeds the predetermined amount.

In another aspect, a locating device is provided comprising a locator module for determining global location, a memory media for storing a plurality of sets of location coordinate data, a microprocessor in communication with the locator module and the memory media, instructions for writing the sets of location coordinate data at chosen time intervals, the chosen time intervals determined by data received from a remote location.

In another aspect, a method of providing the location of a first party to a second party is provide, the method comprising sending via SMS a data packet including positional information to a central controller, converting the positional information sent to the central controller to a voice file, delivering via synthetic voice the positional information to a second party.

In another aspect, a central controller is provided, the controller comprising a receiver for receiving SMS transmissions from a locating device, a memory medium, a microprocessor, and instructions for converting location data in the SMS transmission to a voice file for subsequent voice transmission over a voice connection to a party of interest.

### BRIEF DESCRIPTION OF DRAWINGS

In the drawings, FIG. 1 is a flowchart that illustrates one embodiment showing the relationship between a locating device, a central controller and a remote authorized party;

FIG. 2 is a flowchart illustrating a system embodiment that includes a monitor; and

FIG. 3 is a diagram illustrating one embodiment showing how a boundary area can be constructed.

### DETAILED DESCRIPTION

In one aspect of the invention, a locating device is provided that may allow an interested party to determine the location of a second party from a remote location such as an Internet connection, a cell phone and/or a land line phone. The locating device may be carried by an individual, for example, a child, or may be associated with a piece of property, such as an automobile. The device may include multiple components such as a locating module, e.g., a GPS receiver; a power supply; a wireless receiver and/or transmitter; and electronic memory media such as a flash memory card, a SIM card, a hard drive, or an optical drive; a monitor such as a microphone or camera; and a microprocessor for processing instructions. The device may be in communication with a central controller such as a web panel. The central controller may comprise one or more computers, input and output devices, receivers and transmitters, displays, memory media, and one a more power supplies. One such example of a central controller is a web server, including a modem, and/or TCP/IP connection and/or additional Web, telephone and cellular telephone interfaces. A third component of the system may be a remote receiver such as a telephone, cellular phone, email device or internet connection. The remote receiver may be able to communicate with the central controller and/or with the locating device. Communication between system components may be one way or two way.

The locating device may optionally include a number of modules to provide, for example, position data, one or two-way communication, monitoring functions and/or tracking functions. Different modules may share a power supply or may have individual power supplies. Modules may be controlled and/or linked by one or more microprocessors and/or buses. Instructional code may be stored on one or more memory media associated with the device. The locating device may be any size and shape, although it is preferred that the device be small, robust and unobtrusive. For example, the device may include a portable power supply such as a rechargeable battery and may be about the size of a typical cellular phone, or smaller. The device may include a locator module. The locator module may be able to determine the global position of the device, and therefore the position of a person or object associated with the device. The locator module may provide positioning data using methods known to those of skill in the art, such as Global Positioning System (GPS), Assisted Global Positioning System (A-GPS) GLONASS, Triangulation, inertial, or signal strength determination. RFID (Radio Frequency Identification) technology may be useful in some applications, such as for tracking inside buildings.

The locating device may communicate with another device via a wireless network and/or a wired network, such as the internet. Other types of networks include, for example, Local Area Networks or Wide Area Networks using such communication connections as dial-up, ISDN, Ethernet, token ring, FDDI or other connection methods well known in the art. While cellular communication may be the preferred method of communicating between the central controller and the locating device, any wireless communication such as satellites, microwave, or infrared would provide such wireless communication. The position data received by the locator module of the locating device the GPS satellites can be converted into global position coordinates at the device itself or the raw position data can be passed to the central controller and the global position may be calculated there or elsewhere.

Data, programs and/or prefix numbers may be stored on a Subscriber Identity Modular (SIM) card that is associated with the locating device. The SIM card may be similar or identical to SIM cards available for cellular phones. The SIM card may serve as a storage medium and/or may function as a microprocessor. For example, prefix numbers may be stored on the card and specific instructions may also be written to the card. Firmware may be stored on a SIM card or on separate memory media associated with the locating device.

Position data obtained by the locator module may be in a variety of forms and may be transformed into, for example, latitude and longitude coordinates. This data may be sampled and/or stored at chosen intervals. For instance, latitude and longitude data may be sampled every second and may be stored on memory media with each sampling. In some embodiments, data may be stored at a different rate from which it is sampled. For instance, data may be sampled every second while data may be stored every 10 minutes, every half hour, or every hour, for example. Instructions may be provided so that the latest sampling data overwrites the oldest set of sampling data that has been recorded. Alternatively, the latest set of sampling data may be written to the same location repeatedly, while older sets of sampling data are retained. Sampling and recording frequency may be set by, for example, onboard programming, by the user of the locating device, or by an external authorized party through communication with an external device such as a central controller. In a preferred embodiment, an authorized party may communicate remotely to a central controller, via, for example, an internet connection, a telephone or a cellular phone connection. Once identified as an authorized party, the party may provide instructions to alter the recording frequency from, for example, once an hour to once every 10 minutes or to any other desired frequency. These instructions can then be relayed from the central controller to the locating device using a wireless connection, such as SMS or GPRS messaging. As explained below, the locating device may be programmed to recognize the source of the transmission and, once recognized, will implement the instructions to alter the recording frequency.

Sampling and recording frequency may also be changed by the user of the device under particular situations. For example, the device may be equipped with an emergency button or “SOS” button. The SOS button may be pressed by the user when the user senses a dangerous or emergency situation. In response to activation of the SOS button, the device may proceed with one or more preprogrammed actions. For example, the device may transmit a data string to the central controller that initiates an emergency mode that may relay in emergency message to one a more remote parties. For example, a parent may receive a cellular text message indicating that a child's SOS function has been activated at a particular location at a particular time. In addition, the device may increase sampling or recording frequency of position data and may automatically upload all or some of the stored position data to a central controller in order to provide a track of the child's previous locations. The device may also make a 911 call, either directly or through the central controller, providing information such as, for example, location, time, name of child, age of child, names of parents, and/or others that should be contacted.

The system may also provide a “track” of an individual. For example, a remote authorized party may set a time interval at which location readings are transmitted to a central controller. These sequential readings may then be displayed as a track on a graphical map. Each reading may include the time at which it was recorded.

A locating device may include one or more pre-chosen or “prefix” numbers that may be recognized by the device and may initiate one or more functions when a call from one of the prefix numbers is detected and/or answered. A “detected” call need not be answered but the source of the call can be determined. If a call is “answered”, two-way communication is initiated. In some embodiments, the call is detected but not answered. Prefix call numbers may be associated with specific functions that may be initiated upon detecting and/or answering a call from the identified source. A few possible functions are provided in Table 1. Functions may be defined by the user and/or defined by the supplier. Specific functions associated with a prefix ID may be permanent or temporary.

TABLE 1

| Prefix Number ID | Initiated Function |
|---|---|
| 1 | Send current location data to this prefix |
| | number via a central controller |
| 2 | Silently activate audio monitoring and |
| | provide feed to this prefix number |
| 3 | Supplier ID - allow programming updates |
| | to be downloaded |
| 4 | Send current location data to multiple |
| | remote locations, such as two cell numbers |
| | and an email address. |
| 5 | Send name of party and current location to |
| | police and/or 911 |

The number of prefix number ID's is not limited except by the memory and capability of the system. Of course, additional functions may be pre-programmed or user-programmed into the device.

FIG. 1 provides a diagram describing a case where a parent wishes to know the whereabouts of a child. In this example, a child is the first party, a parent is the second party, and a web panel serves as a central controller. The following actions may be taken using one or more of the systems described herein.

In one case, the second party wishes to know the location of the first party. The second party may proceed by calling the first party (the locating device) using standard cellular phone or telephone calling procedures. The locating device may include in memory one or more pre-set or “prefix” phone numbers. When a call to the locating device is detected, the device can identify the source of the call without answering or before answering. For example, using caller ID technology, locating device 210 determines if the incoming call is from one of the prefix numbers, such as that of cell phone 260. If a match is determined, a specific set of actions may be initiated. If no match is detected, the call may be ignored. One specific action that may be initiated is to provide location information to the second party. This may be done with or without the first party's knowledge.

The locating device 210 may query the location module 212 for its current position. Location module 212 may be, for example, a GPS receiver. This position data may then be sent by the locating device 210 via wireless connection 233 to a central controller 200 or directly to the second party's cell phone 260 via wireless transmission 243. The transmission may be, for example, in the form of an SMS message. The data packet may optionally include, in addition to location data, the time of the transmission, battery strength, velocity, information identifying the source of the request (second party) 260 and the ID of the location device 210 (first party's device). The central controller may receive the data packet and can convert the position data, typically latitude and longitude coordinates, to a physical address (e.g., 100 Main St., Anytown USA) recognizable to the second party.

In another embodiment, a map image may be generated showing the location of the first party. Preferably, the time that the location was read is also provided. The address information, as an image or as text may then be forwarded to the requesting second party or to another location specified by the second party. The central controller may check numbers to confirm that the receiver is authorized to receive the data. Information may be sent to more than one source, for example, information can be sent to cell phone 1, cell phone 2 and/or email 1. Authorized receiving unit ID's may be pre-set by an account holder and may be the unit's phone number. Thus, a second party may initiate an authorized location request directed to the first party's device 210. Device 210 may then provide the location data to a central controller which may then convert or improve the data and provide it to the second party (requester). All this may be done, for example, in less than five minutes or less than one minute.

In another embodiment, the velocity of the locating device may be determined and/or recorded and/or transmitted to a central controller or to a remote authorized party. A locating device, including a location module, can calculate velocity by taking two or more location readings. Appropriate velocity determination methods are known to those skilled in the art. Velocity may be determined by, for example, the locating device or by a central controller. Velocity may be recorded and/or may be used to initiate various actions. For example, if a device exceeds a particular velocity, a message may be sent to a remote party, a message may be sent to the device itself, or the velocity and location may be recorded and saved.

In one embodiment, a locating device may be programmed to notify a remote party, for example via SMS, when a particular device exceeds a velocity of 65 mph. A velocity threshold may also be variable. For example, the velocity threshold may be dependent upon the road over which the device is traveling. By correlating the current position of the device to the road it is traveling on, a speed limit (posted or otherwise determined) for the device may be found. This may be done by the device itself or by communicating with a central controller. For example, if the device is on Main Street in Portland, the program can access a database to determine that the speed limit on Main Street is 30 mph. If that velocity is exceeded, then an action can be automatically initiated. Actions include, for example, sending a message as described herein or recording the incident. Optional speed limits may also be set by an authorized user. For example, a user may wish that a certain vehicle never exceeds 40 mph on a secondary road and 65 mph on a limited access highway. If either of these limits is exceed under those road conditions, the user can be notified or other action can be initiated.

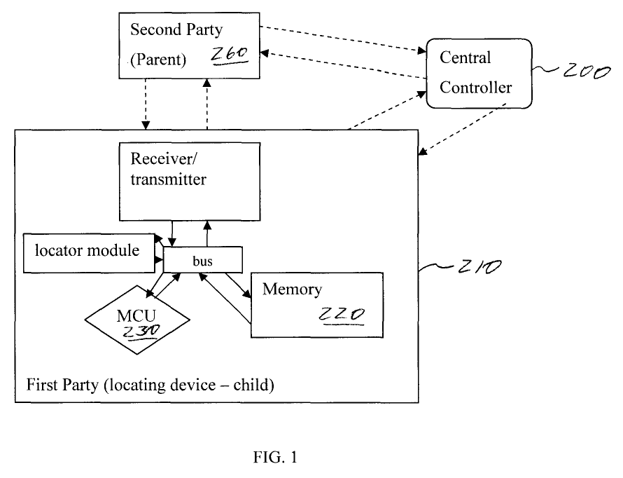

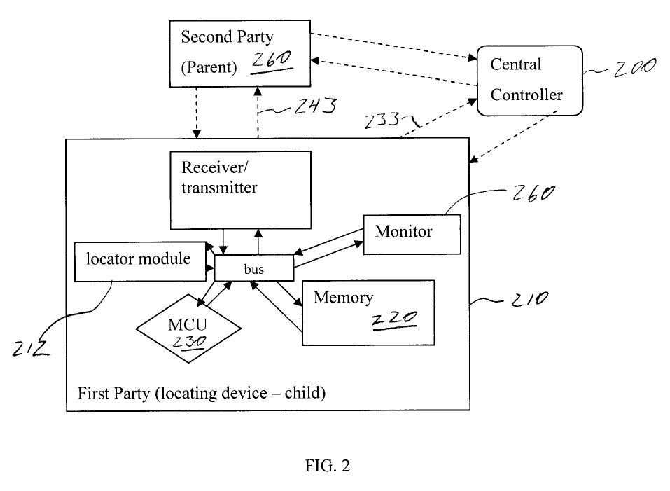

In another embodiment, the second party may monitor the first party's location. Monitoring may include audio and/or visual monitoring. A locating device associated with the first party may include a microphone and/or a camera. Referring to FIG. 2, the second party may be associated with remote device 260 that may be, for example, a cellular phone or networked computer, such as an internet-connected computer. Memory media 220 may be a SIM card. Memory media 220 forms part of locating device 210 that is associated with the first party. Memory media 220 may include one or more “prefix” or prechosen phone numbers that have been previously programmed into the device. The numbers may be known or unknown to the first party. To initiate a monitoring session, second party 260 can call locating device 210 by, for example, calling a phone number associated with the device. Without answering the call, the locating device detects the source of the incoming call using, for example, caller ID capabilities. The locating device may be programmed to either indicate or not indicate that a call is being detected. The locating device can identify the incoming call number and check it against the prefix numbers stored in memory 220. If the incoming call number matches a prefix number that has been previously associated with a “monitor” function, the microprocessor 230 instructs the device to activate monitor 260, for example, a microphone, and to transmit the input from the monitor to the second party, either directly via wireless voice or indirectly to central controller 200. The central controller may then forward the audio and/or video feed to second party 260 or to another designated remote receiver. The process may proceed with or without the knowledge of the first party, providing for the capability of discreet monitoring. Location information may also be provided with the audio and/or video data.

In another embodiment, location information in the form of text may be converted to voice and transmitted to a cellular phone or telephone. Often, a requester of location information may desire to hear the information rather than read it. Information in this form may sometimes be understood more quickly and completely. A locating device may provide information to a central controller that includes data regarding, for example, time, location, person or device ID and the requesting party's ID. As described above, the location information may be converted to recognizable street address form or to known places or to a graphical map. The central controller described herein may be optionally programmed to convert this text information into voice that can be transmitted to the requester. For example, an SMS message may be converted to XML that can be converted to sound by a voice synthesizer. Additional phrases may be added to improve the delivery and the amount of the information that is provided. For example, rather than simply stating a name and location, a voice message may say “Jeremy was at 155 Main Street in Portland at 2:52 pm. His previous location was the Washington Middle School in Portland at 2:10 pm.”

After the remote requester answers a call from the central controller, the central controller transmits the voice message to the requester. After completion of the voice message, the requester may ask for a replay or may use recognizable voice commands such as “where is Jeremy now?” or “Contact me when Jeremy leaves 155 Main Street” to communicate with the central controller. Voice recognition systems to finalize this task are known to those skilled in the art. The central controller may recognize these commands and can proceed with carrying out the requested task or with remotely programming the locating device to do so.

In another embodiment, the device and/or system may be used to construct a boundary area. The device and/or system may include instructions to notify a party, e.g., a parent, if the boundary area is exceeded. This procedure may be referred to as “geofencing.”

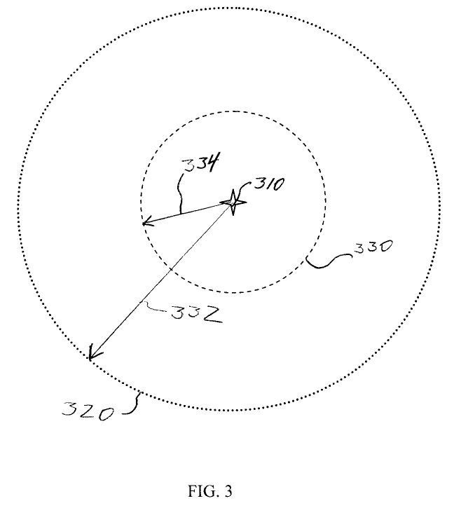

A virtual boundary area may be constructed inside a substantially circular area of a chosen radius. The radius size may be pre-set or may be chosen and/or updated by an authorized party. The geometric center of the boundary area may be set by reading a position of the locating device. For example, a “set” button on the locating device may be pressed to take a current position reading and the reading may be recorded at, for example, the device or at a central controller. An input code may also be required for the “set” feature to be updated. As shown in FIG. 3, set position 310 may form the center (set point) of the boundary area. Boundary radius 332 defines circle 320 and the length of radius 332 may be pre-programmed or may be selected by an authorized party and may be transmitted to the central controller or the device by, for example, SMS or an internet transmission.

When the locating device exceeds the boundary of the chosen radius, one or more of several actions may be initiated. For example, a call may be initiated to a parent's cell phone indicating that the boundary has been exceeded. Other actions include calls to multiple phones, emails or a reminder sent to the locating device itself to remind the person associated with the device that he or she has exceeded the boundary limit. Another action may be to increase the sampling frequency and to provide a stream of new location data to the parent so that the parent can track the device outside of the boundary area. The boundary information and calculations may be done on board the device, may be performed by the central controller, a separate processor or via a combination thereof.

Different radii may be desired at different times or in different locations. For example, a boundary for a child in a backyard may have a smaller radius than does a boundary for a child at a shopping mall. Therefore, when moved to a new environment, the chosen radius may be updated to radius 334 which defines circular area 330.

The system may be programmed to select a boundary radius based on the location of the set point. For example, when the set point is fixed, the system may detect that the point falls within a child's backyard. A preprogrammed “backyard radius” of, for example, 150 feet may be automatically implemented. Likewise, if the system detects that the set point is in a school, the radius may be automatically set to, for example, 500 feet. These pre-set areas may be chosen by a user by delineating certain areas of a map and designating them as “home,” “school,” “mall,” etc. Each designation can be linked to a desired radius. The system can recognize the latitude and longitude of these areas and can thus calculate if a particular set point falls inside or outside a particular area.

In another embodiment, most or all of the boundary setting can be performed on a central controller via a network connection, such as the internet. For instance, using a graphical interface showing a map of the area of concern, a center point and a radius can be chosen. The point and radius can be chosen regardless of the current position of the locating device, and the party associated with the locating device may or may not be aware that geofencing has been initiated. The point may be placed anywhere and the length of the radius may be infinitely adjustable. Various geofenced areas may be saved for future use with the same or a different locating device. The location, size and/or shape of a boundary area may be changed at any time by an authorized party. Geometric areas other than circles may also be used. For example, an irregular polygon may be mapped by choosing points on a map and connecting the points to form the boundary area.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

All references, patents and patent applications and publications that are cited or referred to in this application are incorporated in their entirety herein by reference.

What is claimed is:

1. A method of transmitting a first party's location to a second party comprising:
recognizing at the first party's location a transmission made from the second party to the first party;
transmitting a data packet from the first party's location to a central controller, the data packet including location data and a source identifier that identifies the second party; and
sending the first party's location data from the central controller to the second party's cellular phone and/or email address.

2. The method of claim 1 wherein sending the first party's location data comprises transmitting voice and/or text.

3. The method of claim 1 wherein the transmission made by the second party to the first party is a telephone call, a wireless phone call, a voice over IP, or a wireless SMS call.

4. The method of claim 1 wherein no transmission is made directly from the first party to the second party.

5. The method of claim 1 wherein the location data is transmitted directly from the first party to the second party.

6. A device for providing a first party's location to a second party, the device comprising:
a GPS receiver;
a wireless receiver;
an electronic storage medium;
a microprocessor in communication with the GPS receiver, the wireless receiver and the electronic storage medium;
and
instructions stored on the electronic storage medium, the instructions for determining if the source of an incoming transmission is from a pre-determined originator ID and for sending a data packet to a central controller, the data packet including location data and data identifying the originator ID of the incoming transmission.

7. The device of claim 6 wherein the pre-determined address is a cellular phone or a land line phone.

8. The device of claim 6 wherein the instructions include determining the source of the incoming transmission absent forming a phone connection with the source of the incoming transmission.

9. A system including the device of claim 6 comprising:
a central controller for receiving a transmission from the device and for transmitting the location of the device to the originator ID.

10. The system of claim 9 further comprising transmitting the location of the device to a plurality of predetermined parties.

11. The system of claim 9 wherein the location of the device is transmitted via cellular call, telephone call or email.

12. A method of tracking a locating device, the method comprising:
defining a graphical boundary area on a central controller;
wirelessly transmitting positional data from a locating device to the central controller;
determining if the positional data is inside or outside of the boundary area; and
notifying a third party that the boundary area has been breached.

13. The method of claim 12 wherein the boundary area is defined absent any input from the tracking device.

14. The method of claim 12 wherein the boundary area is defined using at most one positional data point received from the locating device.

15. The method of claim 12 wherein a boundary is breached when the locating device is outside the boundary.

16. The method of claim 12 wherein a boundary is breached when the locating device is inside the boundary.

17. The method of claim 12 wherein notifying comprises at least one of sending a text message, sending a voice message and sending an email.

18. The method of claim 12 comprising notifying a fourth party.

19. The method of claim 12 wherein the graphical boundary is an irregular shape.
